(19) United States
(12) Patent Application Publication
(10) Pub. No.: US 2013/0099974 A1
(43) Pub. Date: Apr. 25, 2013

(54) SWITCHED BEAM SMART ANTENNA APPARATUS AND RELATED WIRELESS COMMUNICATION CIRCUIT

(71) Applicant: Realtek Semiconductor Corp., Hsinchu (TW)

(72) Inventors: Sy-been WANG, Zhubei City (TW); Yu-Cheng CHEN, Tainan City (TW); Ching-Wei LING, Taitung County (TW); Chih-pao LIN, Zhubei City (TW)

(73) Assignee: Realtek Semiconductor Corp., Hsinchu (TW)

(21) Appl. No.: 13/655,181

(22) Filed: Oct. 18, 2012

(30) Foreign Application Priority Data
Oct. 20, 2011 (TW) 100138170

(51) Int. Cl. H01Q 3/24; H01Q 3/00

(52) U.S. Cl. 342/372; 342/374

(57) ABSTRACT

A switched beam smart antenna apparatus is disclosed including: a first, a second, a third, and a fourth beam adjusting elements substantially perpendicular to a substrate; a radiation strip positioned within an area surrounded by the first to fourth beam adjusting elements and substantially perpendicular to the substrate; a first beam control module positioned between the first beam adjusting element and the substrate; a second beam control module positioned between the second beam adjusting element and the substrate; a third beam control module positioned between the third beam adjusting element and the substrate; and a fourth beam control module positioned between the fourth beam adjusting element and the substrate. When the first beam control module turns on the first beam adjusting element, at least one of the second through the fourth beam control modules turns off corresponding beam adjusting element.

### CROSS-REFERENCE TO RELATED APPLICATIONS

This application claims the benefit of priority to Taiwanese Patent Application No. 100138170, filed on Oct. 20, 2011; the entirety of which is incorporated herein by reference for all purposes.

### BACKGROUND

The present disclosure generally relates to wireless communication technology and, more particularly, to a switched beam smart antenna apparatus and related wireless communication circuit.

Antenna is an important component of a wireless communication device, but also occupies considerable area and volume of the circuit module due to the physical restriction. Nowadays, the wireless communication devices are designed to have more utilities and functions. Antennas of fixed radiation field are unable to satisfy the requirements of high end products.

In order to achieve better signal communication quality or further transmission range, the wireless communication device should be able to flexibly change the radiation field of the antenna during operations to concentrate the radiation energy of the antenna toward a desirable direction. However, how to change the radiation field of the antenna is the most important and most complex issue in antenna design.

### SUMMARY

In view of the foregoing, it can be appreciated that a substantial need exists for apparatuses that can increase the degree of freedom in adjusting the radiation field of the antenna while simplifying the design of the antenna.

An example embodiment of a switched beam smart antenna apparatus is disclosed comprising: a first, a second, a third, and a fourth beam adjusting elements substantially perpendicular to a substrate; a radiation strip positioned within an area surrounded by the first to the fourth beam adjusting elements and substantially perpendicular to the substrate; a first beam control module positioned between the first beam adjusting element and the substrate; a second beam control module positioned between the second beam adjusting element and the substrate; a third beam control module positioned between the third beam adjusting element and the substrate; and a fourth beam control module positioned between the fourth beam adjusting element and the substrate; wherein when the first beam control module turns on the first beam adjusting element, at least one of the second through the fourth beam control modules turns off corresponding beam adjusting element.

Another example embodiment of a switched beam smart antenna apparatus is disclosed comprising: a plurality of beam adjusting elements, each of which substantially perpendicular to a substrate; a plurality of beam control modules, each of which positioned between the substrate and one of the plurality of beam adjusting elements; and a radiation strip positioned within an area surrounded by the plurality of beam adjusting elements and substantially perpendicular to the substrate; wherein when one of the plurality of beam control modules turns on corresponding beam adjusting element, at least one of the other beam control modules turns off corresponding beam adjusting element.

An example embodiment of a wireless communication circuit for receiving signals through a switched beam smart antenna apparatus is disclosed. The smart antenna apparatus comprises a plurality of beam adjusting elements, each of which substantially perpendicular to a substrate; a plurality of beam control modules, for respectively turning on or turning off the plurality of beam adjusting elements; and a radiation strip positioned within an area surrounded by the plurality of beam adjusting elements and substantially perpendicular to the substrate. The wireless communication circuit comprises: a signal processing circuit for processing signals received by the smart antenna apparatus; and a control circuit, coupled with the signal processing circuit, for controlling operations of the plurality of beam control modules; wherein when the control circuit controls at least one of the plurality of beam control modules to turn on corresponding beam adjusting element, the control circuit controls at least one of the other beam control modules to turn off corresponding beam adjusting element.

It is to be understood that both the foregoing general description and the following detailed description are example and explanatory only and are not restrictive of the invention, as claimed.

### BRIEF DESCRIPTION OF THE DRAWINGS

FIG. 1 is a simplified schematic diagram of a wireless communication device in accordance with an example embodiment.

FIG. 2 is a top view of the wireless communication device of FIG. 1.

FIG. 3 through FIG. 6 are simplified schematic diagrams of different radiation fields of the wireless communication device of FIG. 1.

FIG. 7 is a simplified schematic diagram of a wireless communication device in accordance with another example embodiment.

FIG. 8 is a top view of the wireless communication device of FIG. 7.

FIG. 9 is a simplified schematic diagram of a wireless communication device in accordance with another example embodiment.

### DETAILED DESCRIPTION

Reference will now be made in detail to embodiments of the invention, which are illustrated in the accompanying drawings.

The same reference numbers may be used throughout the drawings to refer to the same or like parts or components. Certain terms are used throughout the description and following claims to refer to particular components. As one skilled in the art will appreciate, a component may be referred by different names. This document does not intend to distinguish between components that differ in name but not in function. In the following description and in the claims, the term “comprise” is used in an open-ended fashion, and thus should be interpreted to mean “include, but not limited to . . . ” Also, the phrase “coupled with” is intended to compass any indirect or direct connection. Accordingly, if this document mentioned that a first device is coupled with a second device, it means that the first device may be directly or indirectly connected to the second device through electrical connections, wireless communications, optical communications, or other signal connections with/without other intermediate devices or connection means.

As used herein, the term “and/or” includes any and all combinations of one or more of the associated listed items. In addition, the singular forms “a”, “an”, and “the” as used herein are intended to include the plural forms as well, unless the context clearly indicates otherwise.

Throughout the description and following claims, it will be understood that when a component is referred to as being “positioned on,” “positioned above,” “connected to,” “engaged with,” or “coupled with” another component, it can be directly on, connected to, or engaged with the other component or intervening component may be present. In contrast, when a component is referred to as being “directly on,” “directly connected to,” or “directly engaged with” another component, there are no intervening components present.

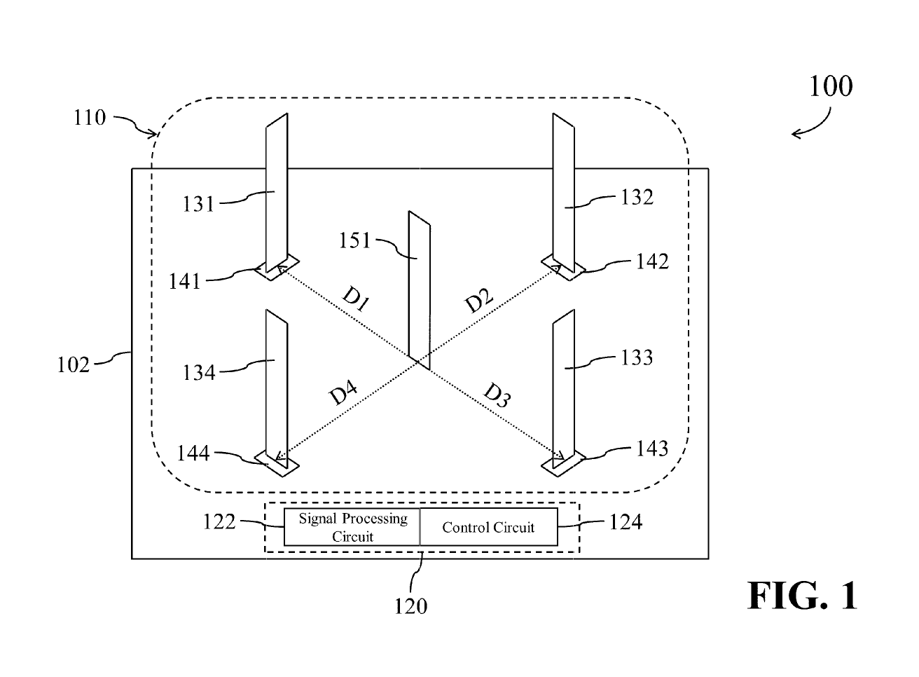

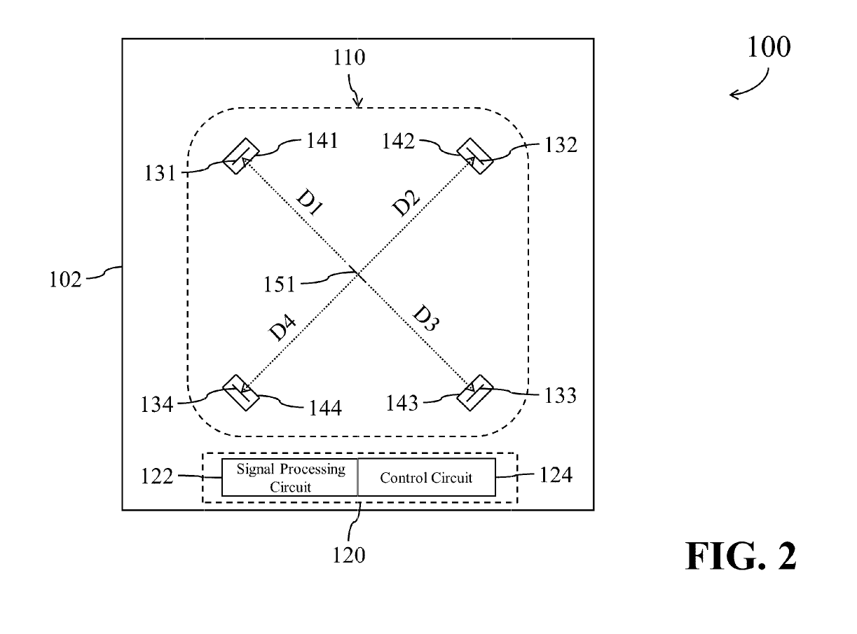

Please refer to FIG. 1 and FIG. 2. FIG. 1 shows a simplified schematic diagram of a wireless communication device 100 in accordance with an example embodiment, and FIG. 2 shows a top view of the wireless communication device 100. The wireless communication device 100 comprises a switched beam high-gain smart antenna apparatus 110 and a wireless communication circuit 120 positioned on a substrate 102. In this embodiment, the smart antenna apparatus 110 comprises four beam adjusting elements 131, 132, 133, and 134, four beam control modules 141, 142, 143, and 144, and a radiation strip 151 which forms a monopole antenna. As shown in FIG. 1, the beam adjusting elements 131˜134 and the radiation strip 151 are substantially perpendicular to the substrate 102, and the radiation strip 151 is positioned within an area surrounded by the beam adjusting elements 131˜134. The substrate 102 has a metal layer on which the beam adjusting elements 131˜134 and the beam control modules 141˜144 can be positioned.

The beam control modules 141˜144 are respectively positioned at the junctions of the beam adjusting elements 131˜134 and the substrate 102 to turn on or turn off the corresponding coupled beam adjusting elements. In other words, the control modules 141˜144 are bridging elements of the beam adjusting elements 131˜134 and the substrate 102. In implementations, the beam control modules 141˜144 may be a switching circuit realized by diodes, transistors, or micro electro mechanical systems (MEMS).

The wireless communication circuit 120 comprises a signal processing circuit 122 and a control circuit 124. The signal processing circuit 122 is coupled with the smart antenna apparatus 110 to process signals received by the smart antenna apparatus 110. The control circuit 124 is coupled with the smart antenna apparatus 110 to control the operations of the beam control modules 141˜144 in the smart antenna apparatus 110.

When the beam control modules 141˜144 are positioned on the substrate 102, control signal lines between the control circuit 124 and the beam control modules 141˜144 can be directly wired on the substrate 102 and needs not to extend to the body of the beam adjusting elements 131˜134. Accordingly, no circuit board for carrying control signal lines should be arranged inside each of the beam adjusting elements 131˜134, and no switching circuit should be arranged on the body of each of the beam adjusting elements 131˜134. As a result, the structure and control complexity of the beam adjusting elements 131˜134 can be effectively reduced.

In implementations, each of the beam adjusting elements 131˜134 and the radiation strip 151 may be realized by a single mental pillar having a cross section of circular, quadrangular or polygonal. In the embodiments of FIG. 1 and FIG. 2, each of the beam adjusting elements 131˜134 and the radiation strip 151 is realized by a single mental sheet in the form of a strip. Such structure facilitates the manufacturing process and reduces the amount of required material. In other embodiments, each of the beam adjusting elements 131˜134 and/or the radiation strip 151 may be realized by a single meandering mental sheet or a single spiral mental strip. In addition, each of the beam adjusting elements 131˜134 may be realized a part of an L-shaped mental strip or a part of an h-shaped mental strip. In one embodiment, the radiation strip 151 may be realized by a metal strip folded in half to form a U-shaped or a V-shaped dipole antenna that is substantially perpendicular to the substrate 102.

For simplicity, other components of the wireless communication device 100 and control signals between the wireless communication circuit 120 and the smart antenna apparatus 110 are omitted in FIG. 1 and FIG. 2.

In the smart antenna apparatus 110, each of the beam adjusting elements 131˜134 has an equivalent current path of a length greater than or equal to a length of an equivalent current path of the radiation strip 151.

In the embodiment of FIG. 1, a gap D1 between the radiation strip 151 and the beam adjusting element 131 is approximately equal to a gap D3 between the radiation strip 151 and the beam adjusting elements 133. In addition, a gap D2 between the radiation strip 151 and the beam adjusting element 132 is approximately equal to a gap D4 between the radiation strip 151 and the beam adjusting element 134.

Preferably, in one embodiment where the operating frequency band of the smart antenna apparatus 110 is between 2.4˜2.5 GHz, each of the gaps D1, D2, D3, and D4 may be set to range from 10˜25 millimeters so as to obtain better antenna gain.

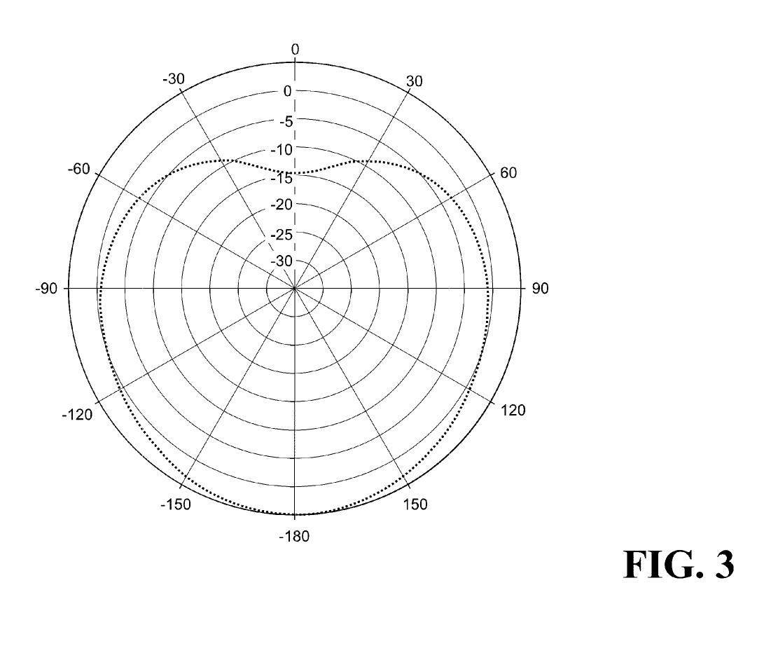

In operations, the control circuit 124 changes the transmission direction of the radiation energy of the radiation strip 151 by controlling the switching operations of the beam control modules 141˜144 to switch the beam adjusting elements cooperating with the radiation strip 151. For example, FIG. 3 is a simplified schematic diagram of the radiation field of the smart antenna apparatus 110 in the case where the control circuit 124 controls the beam control modules 141 and 142 to respectively turn on the beam adjusting elements 131 and 132, and controls the beam control modules 143 and 144 to respectively turn off the beam adjusting elements 133 and 134.

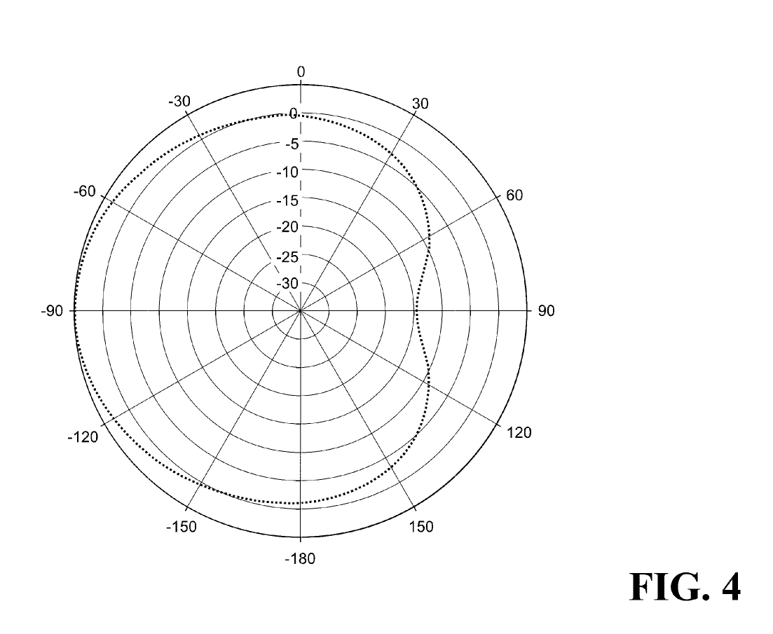

FIG. 4 is a simplified schematic diagram of the radiation field of the smart antenna apparatus 110 in the case where the control circuit 124 controls the beam control modules 142 and 143 to respectively turn on the beam adjusting elements 132 and 133, and controls the beam control modules 141 and 144 to respectively turn off the beam adjusting elements 131 and 134.

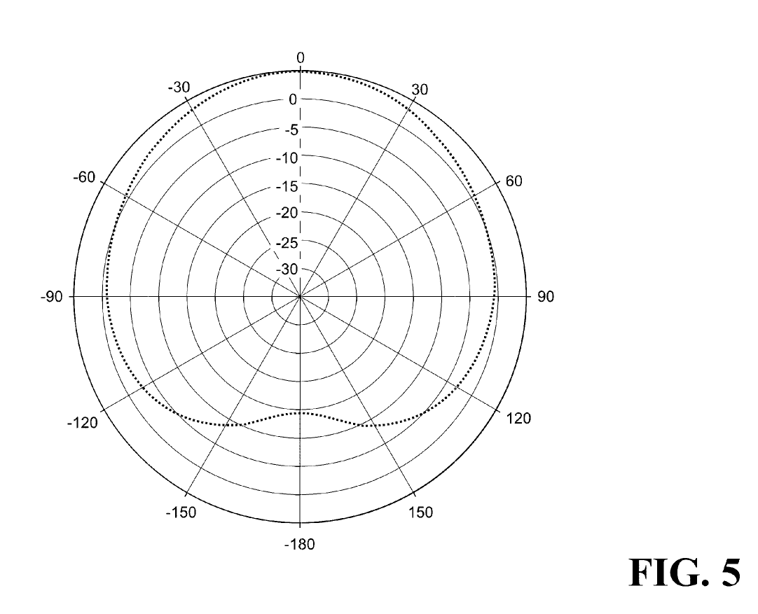

FIG. 5 is a simplified schematic diagram of the radiation field of the smart antenna apparatus 110 in the case where the control circuit 124 controls the beam control modules 143 and 144 to respectively turn on the beam adjusting elements 133 and 134, and controls the beam control modules 141 and 142 to respectively turn off the beam adjusting elements 131 and 132.

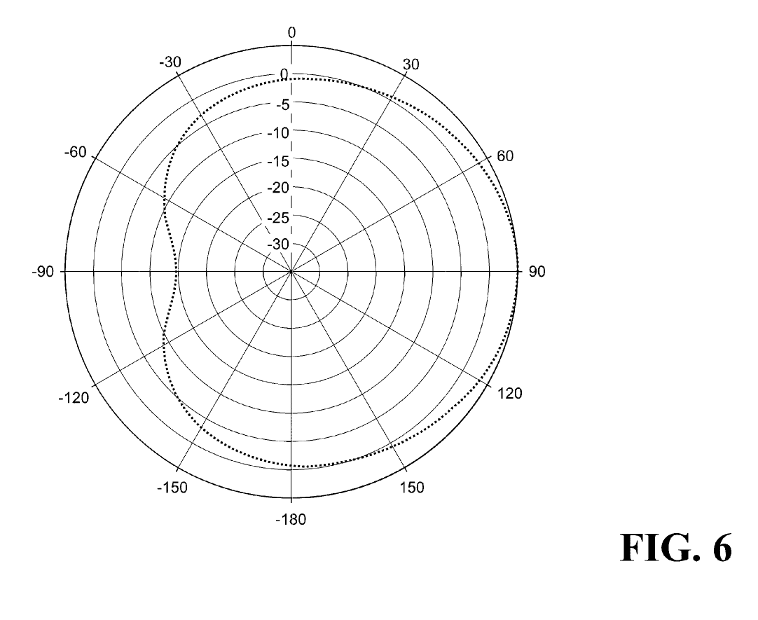

FIG. 6 is a simplified schematic diagram of the radiation field of the smart antenna apparatus 110 in the case where the control circuit 124 controls the beam control modules 141 and 144 to respectively turn on the beam adjusting elements 131 and 134, and controls the beam control modules 142 and 143 to respectively turn off the beam adjusting elements 132 and 133.

In addition, when one of the beam control modules 141˜144 turns on corresponding beam adjusting element, the control circuit 124 may control the other three beam control modules to turn off corresponding beam adjusting elements. Alternatively, the control circuit 124 may control one of the beam control modules 141˜144 to turn off corresponding beam adjusting element while controlling the other three beam control modules to turn on corresponding beam adjusting elements. In above two situations, the radiation fields of the smart antenna apparatus 110 may have slight difference.

As can be appreciated from the foregoing descriptions that the control circuit 124 may control the switching operations of the beam control modules 141˜144 to change the radiation field and transmission direction of radiation energy of the smart antenna apparatus 110, thereby extending the signal coverage of the smart antenna apparatus 110 and increasing the communication range of the wireless communication device 100. Additionally, the wireless communication device 100 may adopt the previous approaches to select a best signal channel in a multi-path reflection area to greatly improve the signal communication quality.

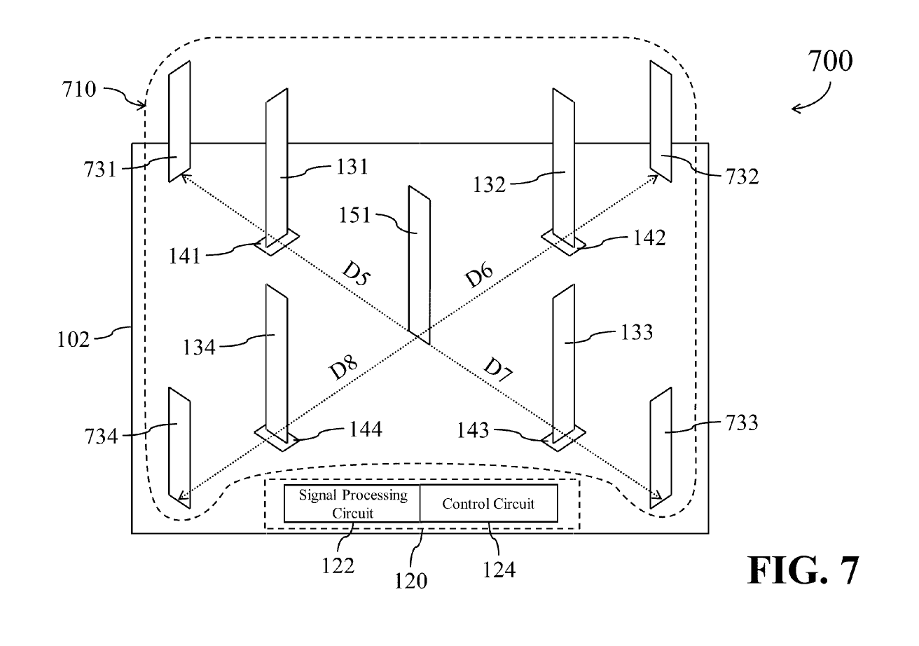

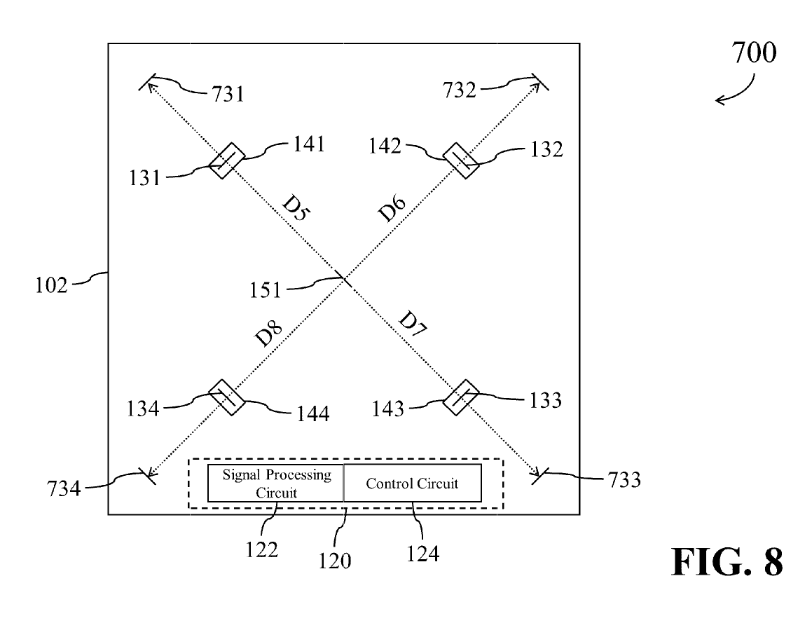

Please refer to FIG. 7 and FIG. 8. FIG. 7 shows a simplified schematic diagram of a wireless communication device 700 in accordance with another example embodiment. FIG. 8 is a top view of the wireless communication device 700. A switched beam high-gain smart antenna apparatus 710 of the wireless communication device 700 has a similar structure as the afore-mentioned smart antenna apparatus 110, but the smart antenna apparatus 710 further comprises four outer beam adjusting elements 731, 732, 733, and 734. The outer beam adjusting elements 731, 732, 733, and 734 are positioned in a periphery of the beam adjusting elements 131˜134 and substantially perpendicular to the substrate respectively. Each of the outer beam adjusting elements 731˜734 has an equivalent current path of a length less than a length of an equivalent current path of the radiation strip 151 and also less than a length of an equivalent current path of each of the beam adjusting elements 131˜134.

In the embodiment of FIG. 7, a gap D5 between the radiation strip 151 and the outer beam adjusting element 731 is approximately equal to a gap D7 between the radiation strip 151 and the outer adjusting element 733. In addition, a gap D6 between the radiation strip 151 and the outer beam adjusting element 732 is approximately equal to a gap D8 between the radiation strip 151 and the outer adjusting element 734.

In the embodiment where the operating frequency band of the smart antenna apparatus 110 is between 2.4˜2.5GHz, each of the gaps D5, D6, D7, and D8 may be set to range from 55 to 65 millimeters so as to obtain better antenna gain.

In implementations, each of the outer beam adjusting elements 731˜734 may be realized by a single mental pillar having a cross section of circular, quadrangular, or polygonal, or may be realized by a single mental sheet in the form of a strip (as shown in FIG. 7 and FIG. 8), so as to facilitate the manufacturing process and reduce required materials. In other embodiments, each of the outer beam adjusting elements 731˜734 may be designed as a single meandering mental sheet or a single spiral mental strip. In addition, each of the outer beam adjusting elements 731˜834 may be realized by a part of an L-shaped or a part of an h-shaped mental strip.

The presence of the outer beam adjusting elements 731˜734 would further concentrate the radiation energy of the radiation strip 151. For example, when the beam control modules 141 and 142 turn on the beam adjusting elements 131 and 132 while the beam control modules 143 and 144 turn off the beam adjusting elements 133 and 134, the presence of the outer beam adjusting elements 731 and 732 would concentrate the radiation field of the radiation strip 151 further than that in the embodiment of FIG. 3.

In another example, when the beam control modules 142 and 143 turn on the beam adjusting elements 132 and 133 while the beam control modules 141 and 144 turn off the beam adjusting elements 131 and 134, the presence of the outer beam adjusting elements 732 and 733 would concentrate the radiation field of the radiation strip 151 further than that in the example embodiment of FIG. 4, thereby further concentrating the radiation energy of the smart antenna apparatus 710. As a result, the signal coverage of the smart antenna apparatus 710 can be extended, thereby increasing the transmission range of the wireless communication device 700 and improving the signal communication quality.

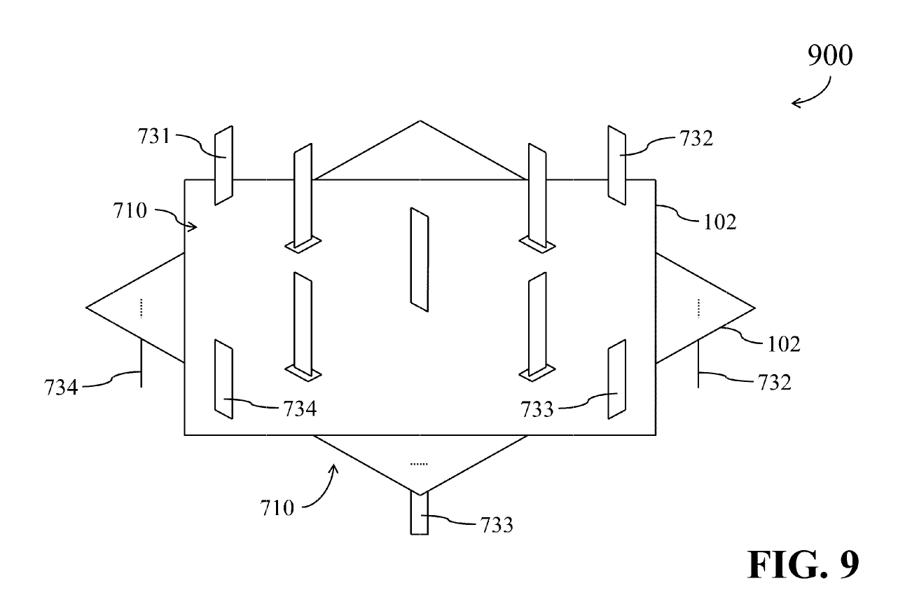

In implementations, the number and positions of the radiation strips, the beam adjusting elements, and the beam control modules of the smart antenna apparatus are not restricted by the previous embodiments. For example, the variation of radiation field of the smart antenna apparatus can be increased by increasing the number of the beam adjusting elements and the beam control modules. Additionally, two sets of smart antenna apparatuses having the afore-mentioned structure may be arranged back-to-back to increase the variation of radiation field of the wireless communication apparatus. For example, FIG. 9 shows an embodiment where two smart antenna apparatuses 710 are arranged back-to-back and one of them is rotated by 45 degrees. In implementations, the rotation angle between the two smart antenna apparatuses may be adjusted depending upon the circuit design requirements, and not restricted by the embodiment in FIG. 9. Additionally, the two smart antenna apparatuses may be positioned on different planes of the same substrate to reduce the required materials.

The afore-mentioned switched beam smart antenna apparatus may be applied in various wireless communication devices, such as a wireless network card, a wireless access point (AP), and any other home appliance capable of supporting wireless communication operations, such as a TV or a DVD player.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A switched beam smart antenna apparatus, comprising:
a first, a second, a third, and a fourth beam adjusting elements substantially perpendicular to a substrate;
a radiation strip positioned within an area surrounded by the first to the fourth beam adjusting elements and substantially perpendicular to the substrate;
a first beam control module positioned between the first beam adjusting element and the substrate;
a second beam control module positioned between the second beam adjusting element and the substrate;
a third beam control module positioned between the third beam adjusting element and the substrate; and
a fourth beam control module positioned between the fourth beam adjusting element and the substrate;
wherein when the first beam control module turns on the first beam adjusting element, at least one of the second through the fourth beam control modules turns off corresponding beam adjusting element.

2. The switched beam smart antenna apparatus of claim 1, wherein when the first beam control module turns on the first beam adjusting element and the second beam control module turns on the second beam adjusting element, the third beam control module turns off the third beam adjusting element.

3. The switched beam smart antenna apparatus of claim 1, wherein the first beam adjusting element has an equivalent current path of a length greater than or equal to a length of an equivalent current path of the radiation strip.

4. The switched beam smart antenna apparatus of claim 3, wherein the radiation strip is positioned between the first beam adjusting element and the third beam adjusting element, and a gap between the radiation strip and the first beam adjusting element is substantially the same as a gap between the radiation strip and the third beam adjusting element.

5. The switched beam smart antenna apparatus of claim 4, wherein the radiation strip is positioned between the second beam adjusting element and the fourth beam adjusting element, and a gap between the radiation strip and the second beam adjusting element is substantially the same as a gap between the radiation strip and the fourth beam adjusting element;
wherein the gap between the radiation strip and the first beam adjusting element ranges from 10 to 25 millimeters, and the gap between the radiation strip and the second beam adjusting element ranges from 10 to 25 millimeters.

6. The switched beam smart antenna apparatus of claim 5, further comprising:
a first, a second, a third, and a fourth outer beam adjusting elements positioned in a periphery of the first to the fourth beam adjusting elements;
wherein each of the first to the fourth outer beam adjusting element has an equivalent current path of a length less than the length of the equivalent current path of the radiation strip.

7. The switched beam smart antenna apparatus of claim 6, wherein each of the first to the fourth outer beam adjusting elements is a single metal sheet, a single metal pillar, a single metal strip, a part of an L-shaped metal strip, or a part of a h-shaped metal strip, and a gap between the radiation strip and the first outer beam adjusting element ranges from 55 to 65 millimeters.

8. The switched beam smart antenna apparatus of claim 1, wherein the radiation strip is a meandering metal sheet, a metal pillar, or a spiral metal strip to form a monopole antenna, or a metal strip folded in half to form a U-shaped or a V-shaped dipole antenna;
wherein each of the first to the fourth beam adjusting elements is a single metal sheet, a single metal pillar, a single metal strip, a part of an L-shaped metal strip, or a part of a h-shaped metal strip.

9. The switched beam smart antenna apparatus of claim 8, wherein the first to the fourth beam control modules are positioned on the substrate.

10. A switched beam smart antenna apparatus, comprising:
a plurality of beam adjusting elements, each of which substantially perpendicular to a substrate;
a plurality of beam control modules, each of which positioned between the substrate and one of the plurality of beam adjusting elements; and
a radiation strip positioned within an area surrounded by the plurality of beam adjusting elements and substantially perpendicular to the substrate;
wherein when one of the plurality of beam control modules turns on corresponding beam adjusting element, at least one of the other beam control modules turns off corresponding beam adjusting element.

11. The switched beam smart antenna apparatus of claim 10, wherein two of the plurality of beam control modules turn on corresponding beam adjusting elements at the same time.

12. The switched beam smart antenna apparatus of claim 10, wherein at least one of the plurality of beam adjusting elements has an equivalent current path of a length greater than or equal to a length of an equivalent current path of the radiation strip.

13. The switched beam smart antenna apparatus of claim 12, wherein the radiation strip is positioned in a center of the area surrounded by the plurality of beam adjusting elements, and a gap between the radiation strip and one of the plurality of beam adjusting elements ranges from 10 to 25 millimeters.

14. The switched beam smart antenna apparatus of claim 12, further comprising:
a plurality of outer beam adjusting elements positioned in a periphery of the plurality of beam adjusting elements;
wherein a first outer beam adjusting element of the plurality of outer beam adjusting elements has an equivalent current path of a length less than the length of the equivalent current path of the radiation strip.

15. The switched beam smart antenna apparatus of claim 14, wherein each of the plurality of outer beam adjusting elements is a single metal sheet, a single metal pillar, a single metal strip, a part of an L-shaped metal strip, or a part of a h-shaped metal strip, and a gap between the radiation strip and one of the plurality of outer beam adjusting element ranges from 55 to 65 millimeters.

16. The switched beam smart antenna apparatus of claim 10, wherein the radiation strip is a meandering metal sheet, a metal pillar, or a spiral metal strip to form a monopole antenna, or a metal strip folded in half to form a U-shaped or a V-shaped dipole antenna.

17. The switched beam smart antenna apparatus of claim 16, wherein the plurality of beam control modules are positioned on the substrate.

18. The switched beam smart antenna apparatus of claim 10, wherein each of the plurality of beam adjusting elements is a single metal sheet, a single metal pillar, a single metal strip, a part of an L-shaped metal strip, or a part of a h-shaped metal strip.

19. A wireless communication circuit for receiving signals through a switched beam smart antenna apparatus, the smart antenna apparatus comprising: a plurality of beam adjusting elements, each of which substantially perpendicular to a substrate; a plurality of beam control modules, for respectively turning on or turning off the plurality of beam adjusting elements; and a radiation strip positioned within an area surrounded by the plurality of beam adjusting elements and substantially perpendicular to the substrate; the wireless communication circuit comprises:
a signal processing circuit for processing signals received by the smart antenna apparatus; and
a control circuit, coupled with the signal processing circuit, for controlling operations of the plurality of beam control modules;
wherein when the control circuit controls at least one of the plurality of beam control modules to turn on corresponding beam adjusting element, the control circuit controls at least one of the other beam control modules to turn off corresponding beam adjusting element.

20. The wireless communication circuit of claim 19, wherein the control circuit controls two beam control modules to turn on corresponding beam adjusting elements.
